(19) United States
(12) Patent Application Publication
(10) Pub. No.: US 2005/0038201 A1
(43) Pub. Date: Feb. 17, 2005

(54) Process for increasing the molecular weight of polyamides

(75) Inventors: Roland Wursche, Dulmen (DE); Andreas Dowe, Borken (DE); Franz-Erich Baumann, Dulmen (DE); Wilfried Bartz, Marl (DE); Martin Himmelmann, Haltern am See (DE); Rainer Goring, Borken (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/918,343

(22) Filed: Aug. 16, 2004

(30) Foreign Application Priority Data
Aug. 16, 2003 (DE) 10337707.7

(51) Int. Cl. C08F 8/40

(52) U.S. Cl. 525/340

(57) ABSTRACT

A process for condensing polyamides to increase their molecular weight, using a compound having at least two carbonate units comprises using a polyamide which, as a result of its preparation, comprises from 5 to 500 ppm of phosphorus in the form of an acidic compound, and adding, to the polyamide, from 0.001 to 10% by weight of a salt of a weak acid, thus eliminating the inhibiting action of the phosphorus compound.

### BACKGROUND OF THE INVENTION

1. Field of the Invention

The present invention relates to a process for condensing polyamides to increase their molecular weight, where the polyamides comprise, as a result of their preparation, a phosphorus-containing catalyst.

2. Description of the Background

Polyamides are macromolecules whose main chain contains the —CO—NH— group. They are obtained either from two different bifunctional monomer units, each of which contains two identical reactive groups, e.g. —NH₂ or —COOH, or from single bifunctional units, each of which bears one amino group and one carboxy group, or can form these groups. By way of example, polyamides are prepared by polycondensation reactions of diamines with dicarboxylic acids, or of aminocarboxylic acids, or by ring-opening polymerization of lactams.

The preparation of polyamide molding compositions which have high melt strength is necessary for many applications. This requirement can arise for reasons such as the enforced use of specific processing methods. One way of meeting this requirement uses polyamides with high molecular weight and consequently high viscosity. Polyamides of this type are produced by a two-stage process. In this, a comparatively low-viscosity prepolymer is first prepared in a pressure reactor, for example as described in Kunststoff-Handbuch [Plastics handbook], volume 3/4 Technische Thermoplaste, Polyamide [Engineering thermoplastics, polyamides]; eds. Becker, Braun; Carl Hanser Verlag, 1998. A protic phosphorus-containing acid, e.g. H₃PO₂, H₃PO₃, or H₃PO₄ is advantageously used as catalyst. Precursors, e.g. esters or nitrites, may also be used for the compounds needed in this process, and the precursors are converted under the reaction conditions into the abovementioned free acids via hydrolysis.

Other examples of compounds suitable as catalysts are organophosphonic acids or organophosphinic acids, or precursors of these. The presence of this catalyst brings about not only improved lactam cleavage at low temperatures, also resulting in a lower content of residual lactam, but also an improvement in the color of the resultant polycondensates, and there is an overall acceleration of the polycondensation reaction. The effects of the catalyzing compounds also extend, of course, to polyamides which do not contain laurolactam, but contain other monomers. The molecular weight of the precursor thus obtained in the first stage of the reaction is then raised to the required final value via reaction of the remaining end groups, for example via solid-phase post-condensation or, by way of alternative, in the melt, and this can take place in an apparatus directly connected to that for the first stage of the reaction. Various typical additives are then added to the resultant high-molecular-weight polyamide, examples being conductivity additives, stabilizers, processing aids, colorants, etc., the method generally used for this being the compounding technique known to the person skilled in the art. The resultant molding composition is then used in applications requiring increased melt viscosity, inter alia in extrusion or coextrusion, for example of tubes, or in blow molding, suction blow molding, 3D blow molding, or in thermoforming, for example of films. However, it is disadvantageous that the raising of the molecular weight to the required level and the introduction of the necessary other constituents of the molding composition are carried out in separate, sequential steps, thus generating additional process costs.

The efficiency of the process would be increased if it were possible to combine the two steps mentioned so that raising of the molecular weight and the introduction of the desired additives would take place in a single stage of the process. Furthermore, to compensate for the molecular weight degradation which often occurs during processing in the melt, due to the action of heat and shear, it is desirable for the molecular weight to be higher than its specified value. Extrusion and blow molding require high-molecular-weight materials with high melt strength. When considering the application sectors for molding compositions with high melt strength it has to be taken into account that molding compositions with high melt strength can not only be processed to give single-layer structures but can also be processed to give multilayer structures together with molding compositions with low melt strength, the deficient melt strength of these being compensated by the greater viscosity of the high melt strength molding composition. A result of this is that the entire composite becomes processable in the abovementioned manner. This method can be used advantageously to produce moldings from multilayer composites which comprise specific functional layers and which would not be obtainable in any other way.

WO 00/66650 describes the use of compounds having at least two carbonate units for condensing polyamides to increase their molecular weight. The properties here are capable of reliable and stable adjustment, and the material condensed to increase its molecular weight can be processed repeatedly without any resultant gel formation or inhomogeneity. An additive based on this principle and intended for adjustment of molecular weight of polyamides is marketed by the company Brüggemann KG with the name Brüggolen M1251. Main applications are in the sector of viscosity adjustment for recycled material composed of PA6 or PA66, reused in molding compositions for extrusion. The additive Brüggolen M1251 is a masterbatch of a low-viscosity polycarbonate, such as Lexan 141, in an acid-terminated PA6. The molecular weight increase results when the polycarbonate reacts with the amino end groups present in the material which is to be condensed to increase its molecular weight.

The effectiveness of the method is demonstrated in WO 00/66650 for the example of condensation of PA6 and PA66 to increase the molecular weight of the material, the corresponding polycondensates being used in pure form in some instances, but in other instances also comprising additives, e.g. glass fibers and montanate.

Surprisingly, however, it has been found that the method described in WO 00/66650 does not lead to any increase in the molecular weight of many polyamides, for example of PA12, of copolyamides based thereon, of PA11, of PA612, or of alicyclic polyamides. The reaction of the amino end groups with the additive which has to occur for this purpose evidently does not take place. It was therefore an object to find a modified process which permits the molecular weight of the materials to be increased simply and reliably, and in a single step, during the compounding process, for materials including the abovementioned and similar polyamides, for which the process as claimed in WO 00/66650 does not successfully increase molecular weight.

### SUMMARY OF THE INVENTION

Surprisingly, it has been found that the problems discussed above arise when a protic phosphorus-containing acid is used as catalyst during the preparation of the polyamide, and that the problems in such a process are eliminated when the base corresponding to a weak acid is added in the form of a salt, the material added advantageously being a salt of a weak acid.

The invention therefore provides a process for condensing polyamides or polyamide molding compositions to increase their molecular weight, where the polyamides or polyamide molding compositions comprise, as a result of their preparation, from 5 to 500 ppm, and in particular at least 20 ppm, of phosphorus in the form of an acidic compound, using a compound having at least two carbonate units, where from 0.001 to 10% by weight, based on the polyamide, of a salt of a weak acid is added to the polyamide or polyamide molding composition.

Thus, the present invention is directed to a process for condensing polyamides or polyamide molding compositions in order to increase the molecular weight thereof, comprising:
adding to a polyamide or a polyamide molding composition containing from 5 to 500 ppm of phosphorus in the form of an acidic compound, (a) from 0.005 to 10% by weight, based on the polyamide, of a compound having at least two carbonate units, and (b) from 0.001 to 10% by weight, based on the polyamide, of a salt of a weak acid.

### DETAILED DESCRIPTION OF THE INVENTION

A polyamide suitable for the purposes of the invention has a structure based on lactams, on aminocarboxylic acids, or on a combination of diamines and dicarboxylic acids. It may, furthermore, contain units with branching effect, for example those derived from tricarboxylic acids, from triamines, or from polyethyleneimine. By way of example, suitable types, in each case in the form of homopolymer or copolymer, are PA6, PA46, PA66, PA610, PA66/6, PA6-T, PA66-T, and also in particular PA612, PA1012, PA11, PA12, or a transparent polyamide. By way of example, transparent polyamides which may be used are:
the product from an isomer mixture of trimethylhexamethylenediamine and terephthalic acid,
the product from bis(4-aminocyclohexyl)methane and decanedioic acid or dodecanedioic acid,
the product from bis(4-amino-3-methylcyclohexyl)methane and decanedioic acid or dodecanedioic acid.

Other suitable materials are polyetheramides based on lactams, on aminocarboxylic acids, on diamines, on dicarboxylic acids, or on polyetherdiamines, and/or on polyetherdiols.

The starting compounds preferably have molecular weights Mₙ greater than 5000, in particular greater than 8000. Preference is given here to those polyamides which have at least some amino end groups. By way of example, at least 30%, at least 40%, at least 50%, at least 60%, at least 70%, at least 80%, or at least 90%, of the end groups are amino end groups.

The inventive process uses at least one compound having at least two carbonate units, its quantitative proportion being from 0.005 to 10% by weight, calculated as a ratio to the polyamide used. This ratio is preferably in the range from 0.01 to 5.0% by weight, particularly preferably in the range from 0.05 to 3% by weight. The term “carbonate” here means carbonic ester, in particular with phenols or with alcohols.

The compound having at least two carbonate units may be of low molecular weight, oligomeric, or polymeric. It may be composed entirely of carbonate units, or it may also have other units. These are preferably oligo- or polyamide units, oligo- or polyester units, oligo- or polyether units, oligo- or polyether ester amide units, or oligo- or polyesteramide units. Compounds of this type may be prepared via known oligo- or polymerization processes, or via polymer-analogous reactions.

WO 00/66650, which is expressly incorporated herein by way of reference, gives a detailed description of suitable compounds having at least two carbonate units.

In the present invention, the polyamide has to comprise a protic phosphorus-containing acid in the form of an active polycondensation catalyst, which may be added either in the form of this substance or in the form of precursors which form the active catalyst under the reaction conditions, or in the form of downstream products of the catalyst. The phosphorus content is determined to DIN EN ISO 11885 by means of ICPOES (Inductively Coupled Plasma Optical Emission Spectrometry), but one may also, by way of example, use AAS (Atomic absorption spectroscopy). It should be noted that other phosphorus-containing components may also be present in molding compositions, as stabilizers for example. In that case, a difference method is used to determine the phosphorus deriving from the polycondensation. The sample preparation technique is then matched to the particular data required.

The reason underlying the inventive effectiveness of the salt of a weak acid is probably that it suppresses the damaging action of the phosphorus compounds present. The pKₐ value of the weak acid here is 2.5 or higher. By way of example, suitable weak acids are selected from carboxylic acids, such as monocarboxylic acids, dicarboxylic acids, tricarboxylic acids, hydroxycarboxylic acids, aminocarboxylic acids, phenols, alcohols, and CH-acidic compounds.

Besides these, salts of weak inorganic acids are also suitable, for example carbonates, hydrogencarbonates, phosphates, hydrogenphosphates, hydroxides, sulfites, examples of suitable metals being alkali metals, alkaline earth metals, metals of main group III, or metals of transition group II. In principle, other suitable cations are organic cations, such as ammonium ions with full or partial substitution by organic radicals.

It is also possible to use salts of weak acids which are a part of macromolecular structures, for example in the form of ionomers of Surlyno (DuPont) type, or in the form of fully or partially saponified polyethylene wax oxidates.

By way of example, the following salts may be listed: aluminum stearate, barium stearate, lithium stearate, magnesium stearate, potassium oleate, sodium oleate, calcium laurate, calcium montanate, sodium montanate, potassium acetate, zinc stearate, magnesium stearate, calcium hydroxide, magnesium hydroxide, sodium phenolate trihydrate, sodium methanolate, calcium carbonate, sodium carbonate, sodium hydrogencarbonate, trisodium phosphate, and disodium hydrogenphosphate.

It is generally advantageous for the compound having at least two carbonate units to be added to the polyamide prior to the compounding process or during the compounding process, and for this compound to be incorporated by thorough mixing. Addition may take place after the compounding process, prior to processing, but in this case care has to be taken that thorough mixing occurs during processing.

The juncture of addition of the salt of a weak acid may be used to control the juncture of molecular weight increase. By way of example, the salt may be metered into the primary melt as soon as the polycondensation is complete, for instance directly into the polycondensation reactor, or into the ancillary extruder. On the other hand, it may also be applied to the polyamide pellets prior to the compounding process, e.g. in a high-temperature mixer or in a tumbling dryer. In another method, the salt is added directly during the processing of the polyamide to give the molding composition, for example together with the other additives. In these instances, the increase in molecular weight takes place before the compounding process begins, or during the compounding process. On the other hand, if the intention is to incorporate fillers or reinforcing agents during the compounding process, or if the melt filtration is to be carried out in association with the molding composition, it can be advantageous for the addition of a salt of a weak acid to be delayed until the compounding step has ended, for example by applying it to the pellets of a molding composition into which the appropriate additive having more than two carbonate units has previously been mixed, or by adding it in the form of a masterbatch, a pellet mixture being the result. The desired increase in molecular weight then takes place when the processor processes the pellets or pellet mixture thus treated, whereupon finished parts are produced, e.g. tubes.

The amount preferably used of the salt of a weak acid is from 0.001 to 5% by weight, and it is particularly preferably used from 0.01 to 2.5% by weight, and the amount used is with particular preference from 0.05 to 1% by weight, based in each case on the polyamide. The inventive process may moreover use the conventional additives used when preparing polyamide molding compositions. Illustrative examples of these are colorants, flame retardants, stabilizers, fillers, lubricants, mold-release agents, impact modifiers, plasticizers, crystallization accelerators, antistatic agents, lubricants, processing aids, and also other polymers which are usually compounded with polyamides.

Examples of these additives are the following:

Colorants: titanium dioxide, white lead, zinc white, lithopones, antimony white, carbon black, iron oxide black, manganese black, cobalt black, antimony black, lead chromate, minium, zinc yellow, zinc green, cadmium red, cobalt blue, Prussian blue, ultramarine, manganese violet, cadmium yellow, Schweinfurter green, molybdate orange, molybdate red, chrome orange, chrome red, iron oxide red, chromium oxide green, strontium yellow, molybdenum blue, chalk, ochre, umber, green earth, burnt siena, graphite, or soluble organic dyes.

Flame retardants: antimony trioxide, hexabromocyclododecane, tetrachloro- or tetrabromobisphenol and halogenated phosphates, borates, chloroparaffins, and also red phosphorus, and stannates, melamine cyanurate and its condensation products, such as melam, melem, melon, melamine compounds, such as melamine pyro- and polyphosphate, ammonium polyphosphate, aluminum hydroxide, calcium hydroxide, and also organophosphorus compounds containing no halogen, e.g. resorcinol diphenyl phosphate or phosphonic esters.

Stabilizers: metal salts, in particular copper salts and molybdenum salts, and also copper complexes, phosphites, sterically hindered phenols, secondary amines, UV absorbers, and HALS stabilizers.

Fillers: glass fibers, glass beads, ground glass fibers, kieselguhr, talc, kaolin, clays, CaF₂, aluminum oxides, and also carbon fibers.

Lubricants: MoS₂, paraffins, fatty alcohols, and also fatty amides. Mold-release agents and processing aids: waxes (montanates), montanic acid waxes, montanic ester waxes, polysiloxanes, polyvinyl alcohol, SiO₂, calcium silicates, and also perfluorinated polyethers.

Plasticizers: BBSA, POBO.

Impact modifiers: polybutadiene, EPM, EPDM, HDPE. Antistatic agents: carbon black, carbon fibers, graphite fibrils, polyhydric alcohols, amines, amides, quaternary ammonium salts, fatty acid esters.

The amounts used of these additives may be the usual amounts known to the person skilled in the art.

The high-molecular polyamide obtained according to the invention or the corresponding molding composition may be further processed by any of the methods of the prior art to give moldings or films, for example by means of injection molding, extrusion (e.g. to give tubes), coextrusion (e.g. to give multilayer tubes or multilayer films), blow molding, suction blow molding, 3D blow molding, or thermoforming (for example of films). With regard to further details, WO 00/66650 is expressly incorporated herein by way of reference.

The invention also provides a method of forming a polyamide molding or film, comprising:
producing a polyamide or polyamide composition according to the process described above and
injection molding, extruding, coextruding, blow molding, suction blow molding, 3D blow molding, or thermoforming the polyamide or polyamide composition to produce a molding or a film.

In one embodiment, the molding or the film has a single-layer structure and is composed of a polyamide condensed in order to increase its molecular weight, or of the corresponding molding composition.

In another embodiment, the molding or the film is a multilayer composite and comprises, as layer, a polyamide condensed as described above in order to increase its molecular weight, or the corresponding molding composition.

In one embodiment, the molding is a tube, a filament or a container. In another embodiment, the molding is a coolant line, a filler neck, this being part of a fuel line system, or is a container, or a tank for a motor vehicle.

### EXAMPLES

The invention will be illustrated by way of example below. The invention is not limited to the following examples.

Description of process:

The appropriate base polymer is fed, together with the appropriate additives, through the inlet neck of a laboratory kneader (Haake Rheocord System 90). The experimental material was brought to the appropriately adjusted melt temperature by means of heating and frictional heat. Once this temperature had been reached, the experimental material was mixed at this temperature for a further 60 seconds. The material, still hot, was then removed from the laboratory kneader. This material was used for the following analyses:

Solution viscosity ηᵣₑₗ to DIN EN ISO 307;
Amino end groups through potentiometric titration, using perchloric acid;
Carboxy end groups through visual titration, using KOH and phenolphthalein as indicator.

The results are shown in Tables 1 to 3. E here means inventive example and CE here means comparative example.

TABLE 1
Comparative examples starting from polyamides prepared
without phosphorus catalyst

| Starting material | Reference | CE 1 | Reference | CE 2 |
|---|---|---|---|---|
| PA12 | 100 | 99.4 | 0 | 0 |
| PA66 | 0 | 0 | 100 | 99 |
| Brüggolen M1251 | 0 | 0.6 | 0 | 1.0 |
| Melt temp. [° C.] | 240 | 240 | 290 | 290 |
| ηᵣₑₗ | 1.96 | 2.23 | 1.79 | 1.91 |
| NH₂ [meq./kg] | 66 | 40.6 | 34.3 | 16.3 |
| COOH [meq./kg] | 20 | 20 | 67 | 65 |

TABLE 2
Activation of Brüggolen M1251 in the case of a PA12 prepared using
hypophosphorous acid as catalyst (phosphorus content 25 ppm)

| Starting material | Reference | CE3 | E1 | E2 | E3 | E4 | E5 | E6 | CE4 | CE5 |
|---|---|---|---|---|---|---|---|---|---|---|
| PA12 | 100 | 99.4 | 99.3 | 99.3 | 99.3 | 99.3 | 99.3 | 99.3 | 99.3 | 99.3 |
| Brüggolen M1251 | 0 | 0.6 | 0.6 | 0.6 | 0.6 | 0.6 | 0.6 | 0.6 | 0.6 | 0.6 |
| Al stearate | 0 | 0 | 0.1 | 0 | 0 | 0 | 0 | 0 | 0 | 0 |
| Ca stearate | 0 | 0 | 0 | 0.1 | 0 | 0 | 0 | 0 | 0 | 0 |
| Li stearate | 0 | 0 | 0 | 0 | 0.1 | 0 | 0 | 0 | 0 | 0 |
| N a oleate | 0 | 0 | 0 | 0 | 0 | 0.1 | 0 | 0 | 0 | 0 |
| Ca laurate | 0 | 0 | 0 | 0 | 0 | 0 | 0.1 | 0 | 0 | 0 |
| Ca montanate | 0 | 0 | 0 | 0 | 0 | 0 | 0 | 0.1 | 0 | 0 |
| Stearic acid | 0 | 0 | 0 | 0 | 0 | 0 | 0 | 0 | 0.1 | 0 |
| Fatty acid ester | 0 | 0 | 0 | 0 | 0 | 0 | 0 | 0 | 0 | 0.1 |
| Melt temp. [° C.] | 240 | 240 | 240 | 240 | 240 | 240 | 240 | 240 | 240 | 240 |
| ηᵣₑₗ | 2.10 | 2.07 | 2.77 | 2.63 | 2.72 | 2.58 | 2.64 | 2.69 | 2.11 | 2.16 |
| NH₂ [meq./kg) | 51.9 | 52.7 | 22 | 24.7 | 23.8 | 26.6 | 29.5 | 27.7 | 40.7 | 43.5 |
| COOH [meq./kg) | 13 | 15 | 7 | 10 | 7 | 6 | 5 | 8 | 8 | 9 |

TABLE 3
Activation of Brüggolen M1251 in the case of other polyamides prepared using
hypophosphorous acid as catalyst (phosphorus content in each case 25 ppm)

| Starting material | Reference | CE6 | E7 | Reference | CE7 | E8 |
|---|---|---|---|---|---|---|
| PA612 | 100 | 99.4 | 99.3 | 0 | 0 | 0 |
| PA PACM12 | 0 | 0 | 0 | 100 | 99.2 | 99.2 |
| Brüggolen M1251 | 0 | 0.6 | 0.6 | 0 | 0.8 | 0.8 |
| Ca stearate | 0 | 0 | 0.1 | 0 | 0 | 0.1 |
| Melt temp. [° C.] | 260 | 260 | 260 | 280 | 280 | 280 |
| ηᵣₑₗ | 1.85 | 1.83 | 2.00 | 1.85 | 1.85 | 1.96 |
| NH₂ [meq./kg] | 96.8 | 97.3 | 79.8 | 40.2 | 41.7 | 18 |
| COOH [meq./kg] | 5 | 9 | 7 | 70 | 69 | 69 |

This application is based on German patent application No. 103 37 707.7 filed on Aug. 16, 2003, and incorporated herein by reference in its entirety.

1. A process for condensing polyamides or polyamide molding compositions in order to increase the molecular weight thereof, comprising:
adding to a polyamide or a polyamide molding composition containing from 5 to 500 ppm of phosphorus in the form of an acidic compound (a) from 0.005 to 10% by weight, based on the polyamide, of a compound having at least two carbonate units, and (b) from 0.001 to 10% by weight, based on the polyamide, of a salt of a weak acid.

2. The process as claimed in claim 1, wherein the polyamide comprises at least 20 ppm of phosphorus in the form of an acidic compound.

3. The process as claimed in claim 1, wherein from 0.001 to 5% by weight of a salt of a weak acid is added to the polyamide or polyamide molding composition.

4. The process as claimed in claim 1, wherein from 0.01 to 2.5% by weight of the salt of a weak acid is added to the polyamide or polyamide molding composition.

5. The process as claimed in claim 1, wherein from 0.05 to 1% by weight of the salt of a weak acid is added to the polyamide or polyamide molding composition.

6. The process as claimed in claim 1, wherein the weak acid has a pKₐ value of 2.5 or higher.

7. The process as claimed in claim 1, wherein the salt of a weak acid is an alkali metal salt, an alkaline earth metal salt, the salt of a metal of main group III, the salt of a metal of transition group II, or an ammonium salt.

8. The process as claimed in claim 1, wherein the weak acid is selected from the group consisting of carboxylic acids, phenols, alcohols, and CH-acidic compounds.

9. The process as claimed in claim 1, wherein the weak acid is a weak inorganic acid.

10. The process as claimed in claim 1, wherein the salt of a weak acid is selected from the group consisting of carbonates, hydrogencarbonates, phosphates, hydrogenphosphates, hydroxides, and sulfites.

11. The process as claimed in claim 1, wherein the salt of a weak acid is selected from the group consisting of aluminum stearate, barium stearate, lithium stearate, magnesium stearate, potassium oleate, sodium oleate, calcium laurate, calcium montanate, sodium montanate, potassium acetate, zinc stearate, magnesium stearate, calcium hydroxide, magnesium hydroxide, sodium phenolate trihydrate, sodium methanolate, calcium carbonate, sodium carbonate, sodium hydrogencarbonate, trisodium phosphate, and disodium hydrogenphosphate.

12. The process as claimed in claim 1, wherein the polyamide has a molecular weight of greater than 5000.

13. The process as claimed in claim 1, wherein the polyamide or polyamide composition contains from 0.01 to 5.0% by weight, based on the polyamide, of the compound having at least two carbonate units.

14. The process as claimed in claim 1, wherein 0.05% to 3% by weight, based on the polyamide, of the compound having at least two carbonate units are added to the polyamide or polyamide molding composition.

15. A method of forming a polyamide molding or film, comprising:
producing a polyamide or polyamide composition according to the process of claim 1, and
injection molding, extruding, coextruding, blow molding, suction blow molding, 3D blow molding, or thermoforming the polyamide or polyamide composition to produce a molding or a film.

16. The method as claimed in claim 15, wherein the molding or the film has a single-layer structure.

17. The method as claimed in claim 15, wherein the molding or the film is a multilayer composite which comprises a layer of the polyamide.

18. The method as claimed in claim 15, wherein the molding is a tube, a filament or a container.

19. The method as claimed in claim 15, wherein the molding is a coolant line, a filler neck, this being part of a fuel line system, or is a container, or a tank for a motor vehicle.
